(19) United States
(12) Patent Application Publication
(10) Pub. No.: US 2021/0181885 A1
(43) Pub. Date: Jun. 17, 2021

(54) LOW-COST FORCE SENSOR

(71) Applicant: Synaptics Incorporated, San Jose, CA (US)

(72) Inventor: Tom R. VANDERMEIJDEN, San Jose, CA (US)

(21) Appl. No.: 16/717,167

(22) Filed: Dec. 17, 2019

(51) Int. Cl. G06F 3/041; G06F 3/044; G01L 1/16

(52) U.S. Cl. CPC G06F 3/0414; H01G 4/12; G01L 1/16; G06F 3/044

(57) ABSTRACT

A sensor apparatus includes a capacitor and detection circuitry operable in at least a first mode and a second mode. When operating in the first mode, the detection circuitry is configured to measure a capacitance of the capacitor. When operating in the second mode, the detection circuitry is configured to monitor a piezoelectric response of the capacitor, where the piezoelectric response is determined based at least in part on the measured capacitance. In some aspects, the detection circuitry may detect a force exerted on the sensor apparatus based at least in part on the piezoelectric response of the capacitor. In some other aspects, the detection circuitry may process user inputs based at least in part on the piezoelectric response of the capacitor.

### TECHNICAL FIELD

The present embodiments relate generally to force sensing.

### BACKGROUND OF RELATED ART

Input devices including force sensor devices (also commonly referred to as pressure sensor devices) are widely used in a variety of electronic systems. Force sensor devices may be used to provide interfaces for the electronic system. Some force sensor devices also have the ability to detect motion of the electronic system. For example, one or more force sensors positioned beneath the input surface may detect movement and/or vibration of the electronic system based, at least in part, on forces exerted on the input surface. Such forces may be interpreted as “tap” inputs to the electronic system. Accordingly, force sensor devices may be used as input devices for larger computing systems (such as touchpads integrated in, or peripheral to, notebook or desktop computers) and/or smaller computing systems (such as touch screens integrated in cellular phones).

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A method and apparatus for force sensing is disclosed. One innovative aspect of the subject matter of this disclosure can be implemented in a sensor apparatus including a capacitor and detection circuitry operable in at least a first mode and a second mode. When operating the first mode, the detection circuitry is configured to measure a capacitance of the capacitor. When operating in the second mode, the detection circuitry is configured to monitor a piezoelectric response of the capacitor, where the piezoelectric response is determined based at least in part on the measured capacitance.

Another innovative aspect of the subject matter of this disclosure can be implemented in a method performed by an input device. The method includes steps of measuring a capacitance of a capacitor coupled to the input device; monitoring a piezoelectric response of the capacitor based at least in part on the measured capacitance; and detecting a force exerted on the input device based at least in part on the piezoelectric response of the capacitor.

### BRIEF DESCRIPTION OF THE DRAWINGS

The present embodiments are illustrated by way of example and are not intended to be limited by the figures of the accompanying drawings.

FIG. 1 shows an example input device within which the present embodiments may be implemented.

FIG. 2 shows block diagram of an input device, in accordance with some embodiments.

FIG. 3 shows an example force sensing apparatus, in accordance with some embodiments.

FIGS. 4A-4C depict example voltage outputs of a force sensing apparatus in response to various stimuli.

FIG. 5 shows another force sensing apparatus, in accordance with some embodiments.

FIG. 6 shows another block diagram of an input device, in accordance with some embodiments.

FIG. 7 is an illustrative flowchart depicting an example force sensing operation, in accordance with some embodiments.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors. The term “processor,” as used herein may refer to any general-purpose processor, conventional processor, special-purpose processor, controller, microcontroller, and/or state machine capable of executing scripts or instructions of one or more software programs stored in memory. The term “voltage source,” as used herein may refer to a direct-current (DC) voltage source, an alternating-current (AC) voltage source, or any other means of creating an electrical potential (such as ground).

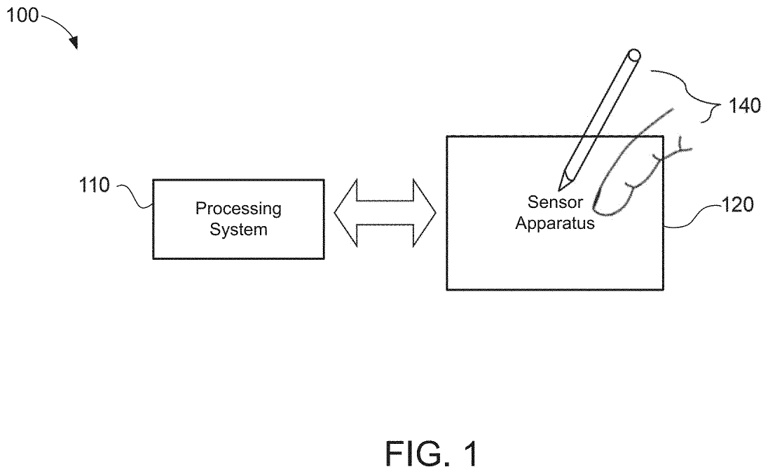

FIG. 1 shows an example input device 100 within which the present embodiments may be implemented. The input device 100 includes a processing system 110 and a sensor apparatus 120. The input device 100 may be configured to provide input to an electronic system (not shown for simplicity). Examples of electronic systems may include personal computing devices (e.g., desktop computers, laptop computers, netbook computers, tablets, web browsers, e-book readers, and personal digital assistants (PDAs)), composite input devices (e.g., physical keyboards, joysticks, and key switches), data input devices (e.g., remote controls and mice), data output devices (e.g., display screens, printers, speakers, and earbuds), remote terminals, kiosks, video game machines (e.g., video game consoles, portable gaming devices, and the like), communication devices (e.g., cellular phones such as smart phones), and media devices (e.g., recorders, editors, and players such as televisions, set-top boxes, music players, digital photo frames, and digital cameras).

In some aspects, the input device 100 may be implemented as a physical part of the corresponding electronic system. Alternatively, the input device 100 may be physically separated from the electronic system. The input device 100 may be coupled to (and communicate with) components of the electronic system using various wired and/or wireless interconnection and communication technologies, such as buses and networks. Examples technologies may include Inter-Integrated Circuit (I²C), Serial Peripheral Interface (SPI), PS/2, Universal Serial bus (USB), Bluetooth®, Infrared Data Association (IrDA), and various radio frequency (RF) communication protocols defined by the IEEE 802.11 standard.

In the example of FIG. 1, the input device 100 may correspond to a force sensor device (e.g., also referred to as a “pressure sensor device”) configured to sense external forces and/or pressure exerted on the input device 100 and/or the electronic system. In some aspects, the external forces may be attributed to one or more input objects 140 in contact with (e.g., tapping or pressing) a surface of the input device 100 and/or the electronic system. Example input objects 140 include fingers, styli, and the like. Thus, the sensor apparatus 120 may be configured to generate force information representative of the force exerted by the input object 140 when making contact with the electronic system. In some other aspects, the external forces may be attributed to movement or vibration of the input device 100 and/or the electronic system (e.g., when the device is dropped onto a hard surface). Thus, the terms “force sensor device” and “motion sensor device” (e.g., also referred to as a “pressure sensor device”) may be used herein interchangeably.

The force information may be in the form of electrical signals representative of an amplitude (or change in amplitude) of the force applied to the input surface. In some embodiments, the sensor apparatus 120 may exhibit a piezoelectric effect under application of force, pressure, stress, vibration, or various forms of motion. For example, the sensor apparatus 120 may comprise a piezoelectric material which produces an electric charge in response to mechanical stress. The amount of charge produced by the piezoelectric material may be proportional to the amount of force or pressure applied. The accumulated charge can be measured as a voltage across the piezoelectric material. Thus, the sensor apparatus 120 may produce electrical signals in response to mechanical disturbances such as those produced by force, pressure, stress, vibration, and/or motion of the sensor apparatus 120.

The processing system 110 may be configured to operate the hardware of the input device 100 to detect input from the sensor apparatus 120. In some embodiments, the processing system 110 may operate the sensor apparatus 120 to detect forces exerted on the electronic system. For example, the processing system 110 may be configured to detect changes in the voltage output of the sensor apparatus 120. In some aspects, one or more components of the processing system 110 may be co-located, for example, in close proximity to the sensing elements of the input device 100. In some other aspects, one or more components of the processing system 110 may be physically separated from the sensing elements of the input device 100. For example, the input device 100 may be a peripheral coupled to a computing device, and the processing system 100 may be implemented as software executed by a central processing unit (CPU) of the computing device. In another example, the input device 100 may be physically integrated in a mobile device, and the processing system 110 may correspond, at least in part, to a CPU of the mobile device.

In some embodiments, the processing system 110 may be implemented as a set of modules that are implemented in firmware, software, or a combination thereof. Example modules include hardware operation modules for operating hardware such as sensor electrodes and display screens; data processing modules for processing data such as sensor signals and positional information; and reporting modules for reporting information. In some embodiments, the processing system 110 may include sensor operation modules configured to operate sensing elements to detect inputs from the sensor apparatus 120 and/or mode changing modules for changing operation modes of the input device 100 and/or electronic system.

The processing system 110 may respond to inputs from the sensor apparatus 120 by triggering one or more actions. Example actions include changing an operation mode of the input device 110 and/or graphical user interface (GUI) actions such as cursor movement, selection, menu navigation, and the like. In some embodiments, the processing system 110 may provide information about the detected input to the electronic system (e.g., to a CPU of the electronic system). The electronic system may then process information received from the processing system 110 to carry out additional actions (e.g., changing a mode of the electronic system and/or GUI actions).

The processing system 110 may operate the sensor apparatus 120 to produce electrical signals indicative of forces (or lack of forces) exerted on the electrical system. The processing system 110 may perform any appropriate amount of processing on the electrical signals to translate or generate the information provided to the electronic system. For example, the processing system 110 may digitize analog signals received from the sensor apparatus 120 and/or perform filtering or conditioning on the received signals. In some aspects, the processing system 110 may subtract or otherwise account for a “baseline” associated with the sensor apparatus 120. For example, the baseline may represent a state of the sensor apparatus 120 when no external force is detected. Accordingly, the information provided by the processing system 110 to the electronic system may reflect a difference between the voltage output detected from the sensor apparatus 120 and an associated baseline voltage.

In some embodiments, the processing system 110 may further determine positional information and/or force information for a detected input. The term “positional information,” as used herein, refers to any information describing or otherwise indicating a position or location of the detected input. Example positional information may include absolute position, relative position, velocity, acceleration, and/or other types of spatial information. Likewise, the term “force information,” as used herein, refers to any information describing or otherwise indicating a force exerted by an input object in contact with (e.g., tapping) a touch surface of the input device 100. For example, the force information may be provided as a vector or scalar quantity (e.g., indicating a direction and/or amplitude). As another example, the force information may include a time history component and/or describe whether the force exerted by the input object exceeds a threshold amount.

In some embodiments, the input device 100 may include a touch screen interface (e.g., display screen) that at least partially overlaps the sensor apparatus 120. For example, the sensor apparatus 120 may be disposed beneath the display screen, thereby providing a tap or touch interface for the associated electronic system. The display screen may be any type of dynamic display capable of displaying a visual interface to a user. Examples of suitable display screen technologies may include light emitting diode (LED), organic LED (OLED), cathode ray tube (CRT), liquid crystal display (LCD), plasma, electroluminescence (EL), or other display technology. In some aspects, the display screen may be controlled or operated, at least in part, by the processing system 110.

As described above, the processing system 110 may detect a force or pressure exerted on the sensor apparatus 120 (e.g., an “input force”) based on a piezoelectric response. For example, the sensor apparatus 120 may include one or more piezoelectric transducers specifically designed and/or optimized to produce a consistent and measurable piezoelectric response under the application of force and/or pressure. However, piezoelectric transducers are manufactured to very precise specifications and therefore tend to be large and expensive. Aspects of the present disclosure recognize that some off-the-shelf circuit components and/or devices are formed from piezoelectric materials (e.g., ceramics, crystals, and the like), and may therefore be suitable for use as a low-cost force or motion sensor.

In some embodiments, the sensor apparatus 120 may comprise a capacitor having a dielectric formed from a piezoelectric material. For example, the capacitor may be a ceramic capacitor having one or more layers of ceramic material acting as the dielectric. Example suitable capacitors include, but are not limited to, multilayer ceramic capacitors (MLCCs), class 2 ceramic capacitors, and various other ferroelectric capacitors. The piezoelectric effect is considered a parasitic property of ceramic capacitors. Thus, in contrast to piezoelectric transducers, many ceramic capacitors are designed to reduce the piezoelectric effect. Aspects of the present disclosure recognize that an off-the-shelf capacitor may exhibit a relatively weak and/or inconsistent piezoelectric response to external stimuli (e.g., force, pressure, vibration, motion, etc.). Thus, in some embodiments, the input device 100 may include additional circuitry to amplify and/or measure the piezoelectric response of the sensor apparatus 120.

Among other advantages, the embodiments described herein provide a low-cost force sensor by repurposing off-the-shelf circuit components for their piezoelectric properties. More specifically, aspects of the present disclosure may leverage a parasitic property of ceramic capacitors to detect input forces and/or motion of the input device 100 or electronic system.

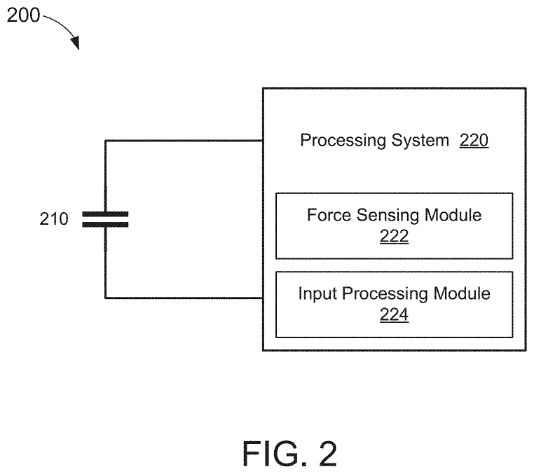

FIG. 2 shows block diagram of an input device 200, in accordance with some embodiments. The input device 200 may be one embodiment of the input device 100 of FIG. 1. Accordingly, the input device 200 may be configured to detect forces exerted on, or motion of, the input device 200 and/or an electronic system (not shown for simplicity) coupled to the input device 200. The input device 200 includes a capacitor 210 and a processing system 220.

The capacitor 210 may be formed from a piezoelectric material. For example, the capacitor 210 may be a ceramic capacitor having one or more layers of ceramic material acting as the dielectric. Example suitable capacitors include, but are not limited to, multilayer ceramic capacitors (MLCCs), class 2 ceramic capacitors, and various other ferroelectric capacitors. In some embodiments, the capacitor 210 may exhibit a piezoelectric effect under application of force, pressure, stress, vibration, or various forms of motion. For example, the capacitor 210 may produce an electric charge in response to mechanical stress. Aspects of the present disclosure recognize that capacitors with higher dielectric constants, lower voltage ratings, and higher layer counts tend to be more susceptible to the piezoelectric effect.

The processing system 220 may be configured to detect the charge accumulated on the capacitor 210 and process inputs based, at least in part, on the accumulated charge. For example, the charge may be detected as a voltage across the capacitor 210 (e.g., an output voltage). The processing system includes a force sensing module 222 and an input processing module 224. The force sensing module 222 may convert the output voltage of the capacitor 210 to force information indicating an amount of force or pressure exerted on the capacitor 210. For example, the change in output voltage may be proportional to the amount of force or pressure applied to the capacitor 210. In some aspects, the force sensing module 222 may compare the output voltage to a baseline voltage of the capacitor 210 (e.g., when no external forces are exerted) to determine the occurrence and/or amplitude of force inputs.

In some aspects, the capacitor 210 may exhibit a change in output voltage in response to certain stimuli unrelated to force or motion. For example, an object (e.g., finger or stylus) in close proximity of the capacitor 210 may affect the output voltage without applying any force or pressure. This change in output voltage may be attributed to a capacitive response, rather than a piezoelectric response, of the capacitor 210. In some embodiments, the force sensing module 222 may be further configured to distinguish a piezoelectric response from a capacitive response of the capacitor 210. As described in greater detail below, the piezoelectric effect generally has a greater impact on the output voltage of the capacitor 210 than its capacitive response to external stimuli. Thus, in some aspects, the force sensing module 222 may distinguish the piezoelectric response of the capacitor 210 from its capacitive response based, at least in part, on the degree and/or rate of change in output voltage.

The input processing module 224 may process inputs based at least in part on the force information received via the capacitor 210. For example, the input processing module 224 may convert the force information from the capacitor 210 to one or more inputs for the input device 200 and/or the electronic system. In some embodiments, the input processing module 224 may correlate the force information with an amount of force or pressure exerted by an input object on the input device 200. For example, the force information may be generated in response to a user tapping or pressing on an input surface of the input device 200. The input processing module 224 may interpret such force information as user inputs. In some aspects, user inputs may be associated with a desired action by the input device 200 and/or the electronic system. Example actions may include, but are not limited to, changing an operation mode of the input device 200 and/or GUI actions such as cursor movement, selection, menu navigation, and the like.

In some other embodiments, the input processing module 224 may correlate the force information with a movement or acceleration of the input device 200. For example, the force information may be generated in response to the input device 200 being dropped, thrown, or pushed across a surface. The input processing module 224 may interpret such force information as motion inputs. In some aspects, one or more motion inputs may be associated with a desired action by the input device 200 and/or the electronic system. However, aspects of the present disclosure recognize that some motion inputs may be unintentional and/or undesired. Thus, in some other aspects, one or more motion inputs may be associated with a preemptive action, for example, to prevent damage to the input device 200 and/or electronic system. Example preemptive actions may include, but are not limited to, cutting off a power supply or otherwise disabling one or more components of the input device 200 and/or electronic system.

Although only one capacitor 210 is depicted in the example of FIG. 2, other implementations of the input device 200 may include two or more capacitors. In some embodiments, the input device 200 may include a matrix of addressable capacitors dynamically configured to transmit and/or receive sound waves or audio signals. In some aspects, one or more voltages may be applied to the matrix of capacitors to induce mechanical vibrations (e.g., using the inverse piezoelectric effect). The mechanical vibrations may be emitted as sound waves from the capacitors. In some other aspects, the capacitors may exhibit varying levels of piezoelectric effect in response to received sound waves. For example, the variations in piezoelectric response may be used for far-field voice tracking (e.g., to track a user of the input device 200).

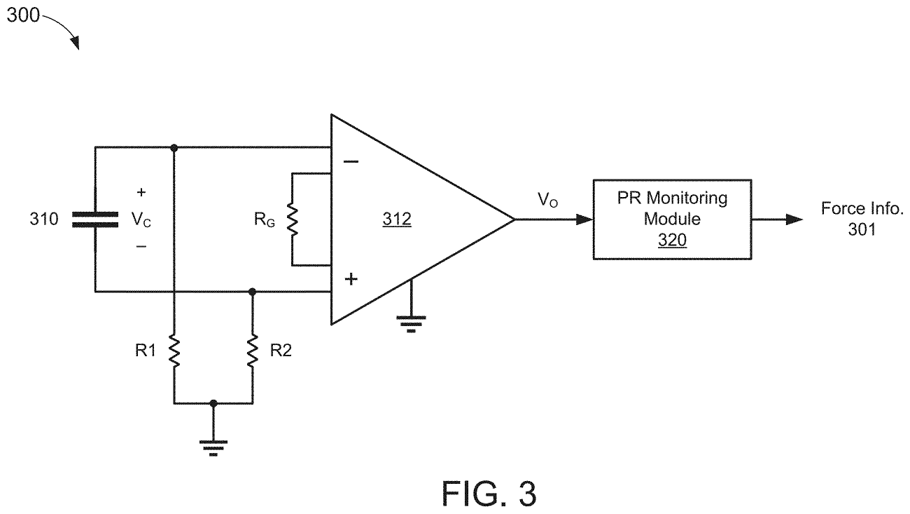

FIG. 3 shows an example force sensing apparatus 300, in accordance with some embodiments. The force sensing apparatus 300 may be one embodiment of the sensor apparatus 120 of FIG. 1. Accordingly, the force sensing apparatus 300 may be configured to generate force information 301 based on forces exerted on, or motion of, the force sensing apparatus 300 and/or an electronic system (not shown for simplicity) coupled to the force sensing apparatus 300. The force sensing apparatus 300 includes a capacitor 310, and a piezoelectric response (PR) monitoring module 320.

The capacitor 310 may be formed from a piezoelectric material. For example, the capacitor 310 may be a ceramic capacitor having one or more layers of ceramic material acting as the dielectric. Example suitable capacitors include, but are not limited to, multilayer ceramic capacitors (MLCCs), class 2 ceramic capacitors, and various other ferroelectric capacitors. In some embodiments, the capacitor 310 may exhibit a piezoelectric effect under application of force, pressure, stress, vibration, or various forms of motion. For example, the capacitor 310 may produce an electric charge in response to mechanical stress. The voltage (V_{C}) across the capacitor can be represented as a function of the capacitance (C) and charge (Q) of the capacitor 310:

$${V}_{C} = \frac{Q}{C}$$

Since the charge Q is proportional to the force (F_{C}) or pressure exerted on the capacitor 310, due to the piezoelectric effect, the above equation can be rewritten as:

$${V}_{C} \approx \frac{{F}_{C}}{C}$$

Thus, a capacitor 310 with a known capacitance C may be used to sense external forces F_{C} by measuring the voltage V_{C} of the capacitor 310:

F_{C}≈C·V_{C} (1)

Aspects of the present disclosure recognize that many ceramic capacitors tend to produce a relatively weak piezoelectric response to external force or pressure. In some embodiments, the capacitor 310 may be disposed in a cavity or via of the force sensing apparatus 300 to increase air flow around the capacitor 310 and thereby improve its piezoelectric response. In some other embodiments, the force sensing apparatus 300 may include an amplifier 312 to amplify the voltage V_{C} of the capacitor 310. In the example of FIG. 3, the amplifier 312 is depicted as an operational amplifier (op amp) having inverting (−) and non-inverting (+) terminals coupled to respective terminals of the capacitor 310, where the difference in voltage between the inverting (V_{IN}⁻) and non-inverting (V_{IN}⁺) terminals is amplified at the output (V_{O}) of the amplifier 312 as a function of its gain (G):

V_{O}=G·(V_{IN}⁺−V_{1N}⁻)=G·V_{C} (2)

In actual implementations, the amplifier 312 may comprise two or more op amps arranged such that the gain G is proportional to a resistance (R_{G}) (e.g., G=1+50KΩ/R_{G}). Resistors R1 and R2 drain a small amount of leakage current away from the amplifier 312 (which would otherwise accumulate on the capacitor 310). In some implementations, the resistors R1 and R2 may have substantially the same, if not identical, resistance values.

The PR monitoring module 320 is configured to monitor a piezoelectric response of the capacitor 310 and generate the force information 301 based, at least in part, on the piezoelectric response. As shown in Equation 1, the amount of force or pressure exerted on the capacitor 310 is proportional to the output voltage V_{O}. In some embodiments, the PR monitoring module 320 may generate the force information 301 by subtracting a baseline voltage (associated with a quiescent state of the capacitor 310) from the output voltage V_{O}. In some other embodiments, when generating the force information 301, the PR monitoring module 320 may filter or otherwise distinguish a piezoelectric response of the capacitor 310 from a capacitive response.

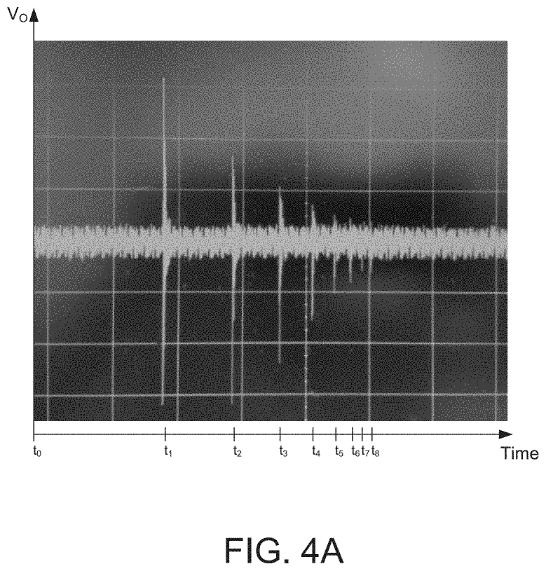

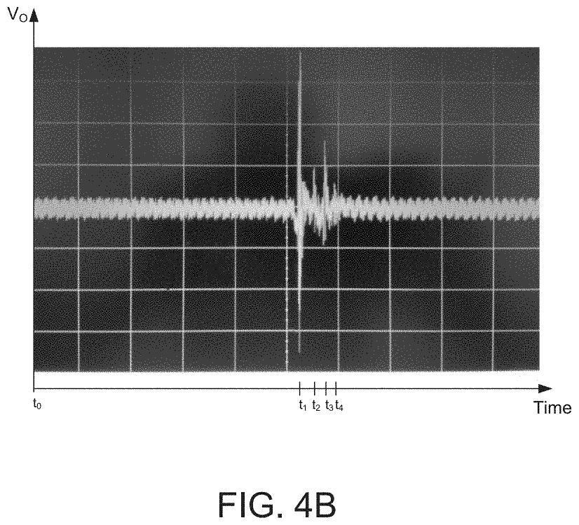

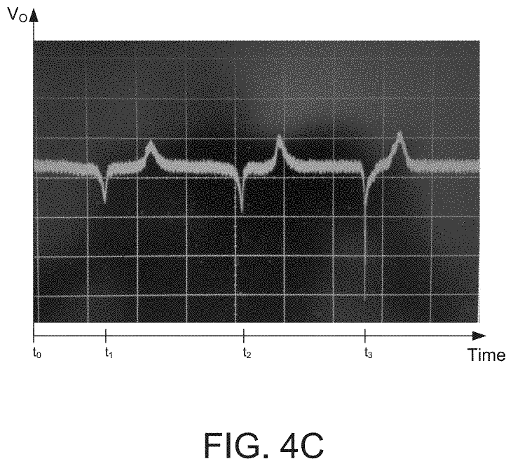

FIGS. 4A-4C show example voltage outputs of a force sensing apparatus in response to various stimuli. With reference for example to FIG. 3, the output voltages depicted in graphs 410-430 may be generated by the force sensing apparatus 300.

FIG. 4A depicts a time-varying voltage output of the force sensing apparatus 300 in response to an input object (e.g., an aluminum rod) being dropped onto an input surface (e.g., plastic housing) of the force sensing apparatus 300. In the example of FIG. 4A, the input object is dropped from a relatively close distance (e.g., ˜3 cm), at time t₁, and bounces off the input surface several times before coming to a rest. Each bounce occurs at a respective one of the times t₁-t₈. As shown in FIG. 4A, the initial impact of the input object (at time t₁) produces the greatest spike in output voltage V_{O}, with successive bounces (at times t₂, t₃, t₄, t₅, t₆, t₇, and t₈) resulting in voltage spikes with diminishing amplitudes. The rate of change in the output voltage V_{O} tracks the damped harmonic motion of the input object bouncing on the input surface. Thus, the spikes in output voltage V_{O} at times t₁, t₂, t₃, t₄, t₅, t₆, t₇, and t₈ can be attributed to the piezoelectric response of the capacitor 310.

FIG. 4B depicts a time-varying voltage output of the force sensing apparatus 300 in response to the force sensing apparatus 300 being dropped onto a hard surface (e.g., a table). In the example of FIG. 4B, the force sensing apparatus 300 is dropped from a relatively close distance (e.g., ˜2.5 cm), at time t₁, and bounces off the hard surface before coming to a rest. Each bounce occurs at a respective one of the times t₁-t₈. As shown in FIG. 4B, the initial impact of the force sensing apparatus 300 (at time t₁) produces the greatest spike in output voltage V_{O}, with successive bounces (at time t₂, t₃, and t₄) resulting in voltage spikes with diminishing amplitudes. The rate of change in the output voltage V_{O} tracks the damped harmonic motion of the force sensing apparatus 300 bouncing on the hard surface. Thus, the spikes in output voltage V_{O} at times t₁, t₂, t₃, and to can be attributed to the piezoelectric response of the capacitor 310.

FIG. 4C depicts a time-varying voltage output of the force sensing apparatus 300 in response to an input object (e.g., a human finger) touching, tapping, or otherwise pressing against the input surface (e.g., plastic housing) of the force sensing apparatus 300. In the example of FIG. 4C, the input object makes contact with the input surface at three distinct times t₁, t₂, and t₃. The first two touch events (at times t₁ and t₂) correspond to light finger touches, whereas the third touch event (at time t₃) correspond to a hard press. As shown in FIG. 4C, the light touches (at times t₁ and t₂) produce relatively small spikes in output voltage V_{O}, whereas the hard press (at time t₃) produces a much more significant spike in the output voltage V_{O}. Since the light touches are unlikely to trigger a piezoelectric response by the capacitor 310, the first two spikes in the output voltage V_{O} (at times t₁ and t₂) can be attributed to a capacitive response of the capacitor 310. In contrast, the hard press is much more likely to trigger a piezoelectric effect. Thus, the final spike in output voltage V_{O} (at time t₃) can be attributed to the piezoelectric response of the capacitor 310.

Aspects of the present disclosure recognize that the piezoelectric response of the capacitor 310 (e.g., at time t₃) may be distinguished or filtered from its capacitive response (e.g., at times t₁ and t₂) based on the amplitude of the output voltage V_{O} and/or the rate of change of the output voltage V_{O}. In some embodiments, the PR monitoring module 320 may sense the piezoelectric response of the capacitor 310 when the output voltage V_{O} exceeds a threshold amount. In some other embodiments, the PR monitoring module 320 may sense the piezoelectric response of the capacitor 310 when the output voltage V_{O} exceeds a threshold rate of change.

As shown in Equation 1, the force information 301 depends not only on the voltage measured across the capacitor 310, but also on the capacitance of the capacitor 310. However, aspects of the present disclosure recognize that the capacitance values of ceramic capacitors tend to vary due to process and temperature. For example, two capacitors made to the same specification may have slightly different capacitance values. Even the same capacitor may exhibit different capacitance values at different times (e.g., under varying temperatures and/or operating conditions). As a result, changes in the measured output voltage V_{O} may be attributable to changes in the force exerted on the capacitor 310 and/or the capacitance of the capacitor 310. To ensure consistent and accurate force information, it may be desirable to take into account any variations in the capacitance of the capacitor 310. In some embodiments, a force sensing apparatus may include circuitry to measure the capacitance of the capacitor to be used in force sensing applications.

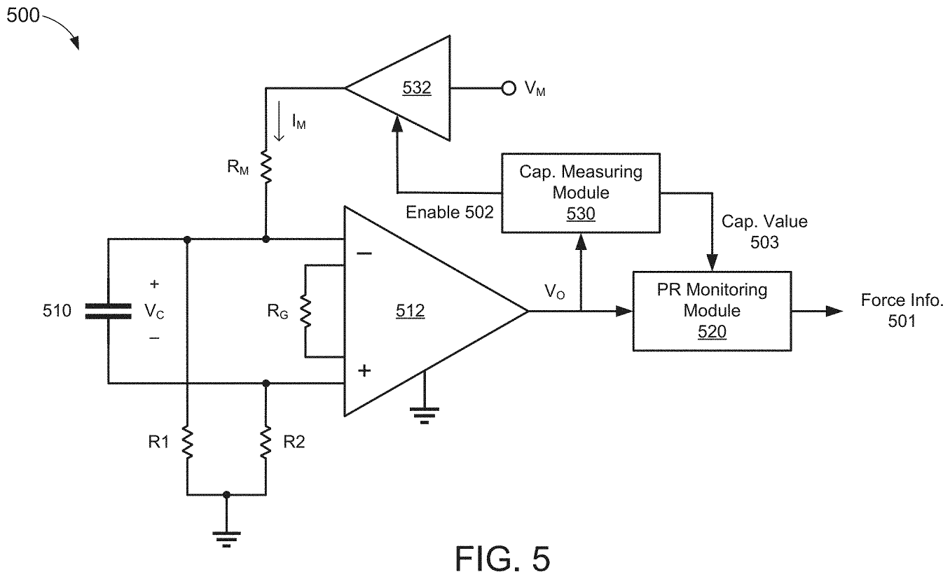

FIG. 5 shows another force sensing apparatus 500, in accordance with some embodiments. The force sensing apparatus 500 may be one embodiment of the sensor apparatus 120 of FIG. 1. Accordingly, the force sensing apparatus 500 may be configured to generate force information 501 based on forces exerted on, or motion of, the force sensing apparatus 500 and/or an electronic system (not shown for simplicity) coupled to the force sensing apparatus 500. The force sensing apparatus 500 includes a capacitor 510, a PR monitoring module 520, and a capacitance measuring module 530.

The capacitor 510 may be formed from a piezoelectric material. For example, the capacitor 310 may be a ceramic capacitor having one or more layers of ceramic material acting as the dielectric. With reference for example to FIG. 3, the capacitor 510 may be an embodiment of the capacitor 310. Thus, the capacitor 510 may exhibit a piezoelectric effect under application of force, pressure, stress, vibration, or various forms of motion. As described with respect to FIG. 3, the force F_{C} exerted on the capacitor 510 may be proportional to the capacitance C of the capacitor 510 and the voltage V_{C} across the capacitor 510.

In some embodiments, the force sensing apparatus 500 may include an amplifier 512 to amplify the voltage V_{C} of the capacitor 510. With reference for example to FIG. 3, the amplifier 512 may be one embodiment of the amplifier 312. Thus, the output V_{O} of the amplifier may be a function of its gain G and the voltage V_{C} of the capacitor 510 (e.g., as shown in Equation 2). In some implementations, the gain G may be proportional to the resistance R_{G}. Resistors R1 and R2 drain a small amount of leakage current away from the amplifier 512 (which would otherwise accumulate on the capacitor 510). In some implementations, the resistors R1 and R2 may have substantially the same, if not identical, resistance values.

The PR monitoring module 520 is configured to monitor a piezoelectric response of the capacitor 510 and generate the force information 501 based, at least in part, on the piezoelectric response. As described above, the amount of force or pressure exerted on the capacitor 510 is proportional to the output voltage V_{O}. In some embodiments, the PR monitoring module 520 may generate the force information 501 by subtracting a baseline voltage (associated with a quiescent state of the capacitor 510) from the output voltage V_{O}. In some other embodiments, when generating the force information 501, the PR monitoring module 520 may filter or otherwise distinguish a piezoelectric response of the capacitor 510 from a capacitive response.

The capacitance measuring module 530 may be configured to measure the capacitance of the capacitor 510. As described above, the capacitance of the capacitor 510 may change under varying temperatures and/or operating conditions. Moreover, as shown in Equation 1, the force information 501 may vary with respect to variations in the capacitance of the capacitor 510. Thus, to ensure that the PR monitoring module 520 is able to generate consistent and accurate force information 501, the capacitance measuring module 530 may provide the measured capacitance value 503 to the PR monitoring module 520.

In some embodiments, the capacitance measuring module 530 may provide a current (I_{M}) to the capacitor 510 when measuring the capacitance value 503. For example, the capacitor 510 may be switchably coupled to a current source comprising a reference voltage (V_{M}) having a known voltage potential and a resistor (R_{M}) having a known resistance value. In the example of FIG. 5, a tri-state buffer 532 is used as a switch between the current source (e.g., V_{M}) and the capacitor 510. However, in other embodiments, any suitable switching means may be used (e.g., switches, transistors, logic gates, and the like). The tri-state buffer 532 may be activated by an enable signal 502 under the control of the capacitance measuring module 530.

When measuring the capacitance of the capacitor 510, the capacitance measuring module 530 may assert or activate the enable signal 502 to couple the capacitor 510 to the reference voltage V_{M}. This causes the current I_{M} to flow through, and charge, the capacitor 510. While the capacitor 510 is charging, the capacitance measuring module 530 may measure the voltage response of the capacitor 510 (e.g., via the output voltage V_{O}) to determine the capacitance value 503. For example, the charging of the capacitor 510 will follow an RC time constant curve:

$${V}_{C} ( t ) = {V}_{M} ( 1 - {e}^{- \frac{t}{R C}} )$$

In the equation above, C is the capacitance of the capacitor 510 and R is the series resistance. Since all voltage and resistor values in the sensor apparatus 500 are known with a high level of precision, the capacitance C can be determined from the voltage response curve. After determining the capacitance C of the capacitor 510, the capacitance measuring module 530 may deassert the enable signal 502 (e.g., to decouple the current source from the capacitor 510) and provide the measured capacitance C to the PR monitoring module 520 (e.g., as the capacitance value 503).

Deasserting the enable signal 502 decouples the current source (e.g., V_{M}) from the capacitor 510 and allows the voltage of the capacitor 510 to discharge (e.g., to its baseline voltage). The discharging of the capacitor 510 may also follow an RC time constant curve. Thus, in some other embodiments, the capacitance measuring module 530 may determine the capacitance C of the capacitor based on the voltage response curve associated with the discharging of the capacitor 510.

Aspects of the present disclosure recognize that the charging of the capacitor 510 (e.g., using the current I_{M}) affects the output voltage V_{O} of the force sensing apparatus 500. As a result, it may be difficult (if not impossible) to accurately measure the piezoelectric response of the capacitor 510 while concurrently determining its capacitance. In some embodiments, the force sensing apparatus 500 may be configured to switch between a capacitance measuring mode and a piezoelectric response (PR) monitoring mode. In some aspects, the force sensing apparatus 500 may operate in the capacitance measuring mode at device startup and may subsequently operate in the PR monitoring mode thereafter. In some other aspects, the force sensing apparatus 500 may periodically switch between the capacitance measuring mode and the PR monitoring mode.

When operating in the capacitance measuring mode, the capacitance measuring module 530 may provide the current Inn to the capacitor 510 while monitoring the voltage response of the capacitor 510 to determine its capacitance value 503. During this time, the PR monitoring module 520 may not monitor the piezoelectric response of the capacitor 510. When operating in the PR monitoring mode, the PR monitoring module 520 may monitor the piezoelectric response of the capacitor 510 (e.g., to external forces) to determine the force information 501. During this time, the capacitance measuring module 530 may not provide the current Inn to the capacitor 510. In some embodiments, the PR monitoring module 520 may use the capacitance value 503 in calculating the force information 501.

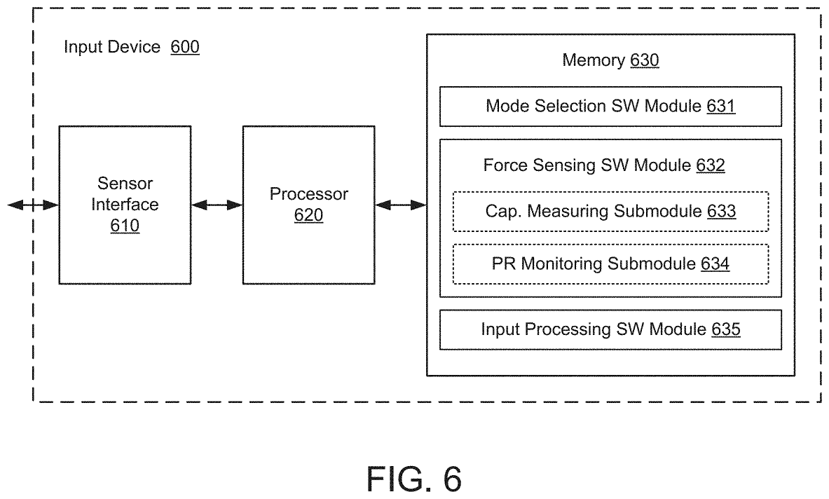

FIG. 6 shows another block diagram of an input device 600, in accordance with some embodiments. The input device 600 may be one embodiment of the input device 110 of FIG. 1 and/or the input device 200 of FIG. 2. Accordingly, the input device 600 may be configured to detect forces exerted on, or motion of, the input device 600 and/or an electronic system (not shown for simplicity) coupled to the input device 600. The input device 600 includes a sensor interface 610, a processor 620, and a memory 630.

The sensor interface 610 may be coupled to a sensor apparatus that is operable to detect forces or pressure exerted thereon. In some embodiments, the sensor apparatus may comprise a capacitor formed from a piezoelectric material. For example, the sensor apparatus may be a ceramic capacitor having one or more layers of ceramic material acting as the dielectric. The sensor interface 610 may be used to communicate with the capacitor. In some aspects, the sensor interface 610 may be configured to detect a voltage (or change in voltage) across the capacitor. In some other aspects, the sensor interface 610 may be configured to transmit signals to, and receive resulting signals from, the capacitor.

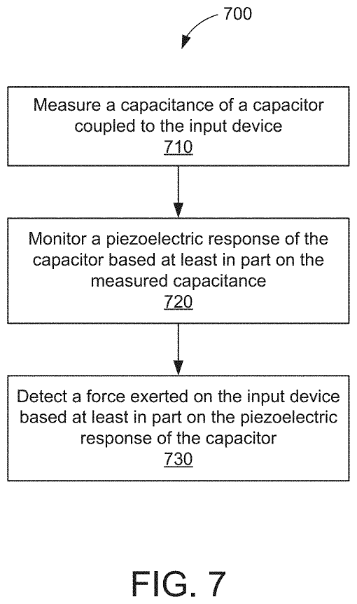

The memory 630 may include a non-transitory computer-readable medium (e.g., one or more nonvolatile memory elements, such as EPROM, EEPROM, Flash memory, a hard drive, etc.) that may store at least the following software (SW) modules:
a mode selection SW module 631 to select an operating mode for the input device 600, the operating modes include at least a capacitance sensing mode and a piezoelectric response (PR) monitoring mode;
a force sensing SW module 632 to measure a force exerted on the capacitor, the force sensing SW module 632 including:
   a capacitance measuring submodule 633 to measure a capacitance of the capacitor when operating in the capacitance sensing mode; and
   a PR monitoring submodule 634 to monitor a piezoelectric response of the capacitor when operating in the PR monitoring mode; and
an input processing SW module 635 to process inputs for the input device 600 and/or the electronic system based, at least in part, on the piezoelectric response of the capacitor.
   Each software module includes instructions that, when executed by the processor 620, cause the input device 600 to perform the corresponding functions. The non-transitory computer-readable medium of memory 630 thus includes instructions for performing all or a portion of the operations described below with respect to FIG. 7.

Processor 620 may be any suitable one or more processors capable of executing scripts or instructions of one or more software programs stored in the input device 600 (e.g., within memory 630). For example, the processor 620 may execute the mode selection SW module 631 to select an operating mode for the sensor apparatus. The processor 620 may also execute the force sensing SW module 632 to measure a force exerted on the capacitor. In executing the force sensing SW module 632, the processor 620 may further execute the capacitance measuring submodule 633 and/or the PR monitoring submodule 634. For example, the processor 620 may execute the capacitance measuring submodule 633 to measure a capacitance of the capacitor when operating in the capacitance sensing mode. The processor 620 may execute the PR monitoring submodule 634 to monitor a piezoelectric response of the capacitor when operating in the PR monitoring mode. Still further, the processor 620 may execute the input processing SW module 635 to process inputs for the input device 600 and/or the electronic system based, at least in part, on the piezoelectric response of the capacitor.

FIG. 7 is an illustrative flowchart depicting an example force sensing operation 700, in accordance with some embodiments. With reference for example to FIG. 6, the operation 700 may be performed by the input device 600 to detect forces exerted on a capacitor.

The input device may measure a capacitance of a capacitor coupled to the input device (710). For example, the input device may provide a current to the capacitor when measuring the capacitance of the capacitor. With reference for example to FIG. 5, a current source (e.g., V_{M}) may be switchably coupled to the capacitor operating in a capacitance measuring mode. The provided current I_{M} charges the capacitor 510 to the reference voltage V_{M}. While the capacitor 510 is charging, the input device may measure the voltage response of the capacitor to determine its capacitance value. For example, the charging of the capacitor will follow an RC time constant curve which can be used to determine the capacitance C of the capacitor.

The input device further monitors a piezoelectric response of the capacitor based at least in part on the measured capacitance (720). For example, the capacitor may be a ceramic capacitor having one or more layers of ceramic material acting as the dielectric. Example suitable capacitors include, but are not limited to, multilayer ceramic capacitors (MLCCs), class 2 ceramic capacitors, and various other ferroelectric capacitors. In some embodiments, the capacitor may exhibit a piezoelectric effect under application of force, pressure, stress, vibration, or various forms of motion. For example, the capacitor may exhibit a change in voltage in response to mechanical stress. The voltage depends on the capacitance of the capacitor. Thus, when monitoring the piezoelectric response, the input device may take into account the measured capacitance of the capacitor.

The input device may detect a force exerted on the input device based at least in part on the piezoelectric response of the capacitor (730). As described above, the amount of force or pressure exerted on the capacitor is proportional to the measured voltage across the capacitor. In some embodiments, the input device may generate force information by subtracting a baseline voltage (associated with a quiescent state of the capacitor) from the measured voltage of the capacitor. In some other embodiments, when generating the force information, the input device may filter or otherwise distinguish a piezoelectric response of the capacitor from a capacitive response.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

1. A sensor apparatus, comprising:
a capacitor; and
detection circuitry operable in at least a first mode and a second mode, the detection circuitry being configured to:
measure a capacitance of the capacitor when operating in the first mode; and
monitor a piezoelectric response of the capacitor when operating in the second mode, wherein the piezoelectric response is monitored based at least in part on the measured capacitance.

2. The sensor apparatus of claim 1, wherein the capacitor comprises a ceramic dielectric material.

3. The sensor apparatus of claim 1, wherein the capacitor is a class 2 multi-layer ceramic capacitor (MLCC).

4. The sensor apparatus of claim 1, wherein the detection circuitry is further configured to:
provide a current to the capacitor when operating in the first mode;
measure a voltage response of the capacitor resulting from the current; and
determine the capacitance of the capacitor based at least in part on the measured voltage response.

5. The sensor apparatus of claim 1, further comprising:
a current source switchably coupled to the capacitor, wherein the current source is coupled to the capacitor when operating in the first mode and is decoupled from the capacitor when operating in the second mode.

6. The sensor apparatus of claim 5, wherein the current source is switchably coupled to the capacitor via a tri-state logic gate.

7. The sensor apparatus of claim 1, wherein the detection circuitry operates in the first mode upon startup of the sensor apparatus and operates in the second mode thereafter.

8. The sensor apparatus of claim 1, wherein the detection circuitry periodically switches between the first mode and the second mode.

9. The sensor apparatus of claim 1, wherein the detection circuitry is further configured to:
detect a force exerted on the sensor apparatus based at least in part on the piezoelectric response of the capacitor.

10. The sensor apparatus of claim 1, wherein the detection circuitry is further configured to:
process user inputs based at least in part on the piezoelectric response of the capacitor.

11. A method performed by an input device, comprising:
measuring a capacitance of a capacitor coupled to the input device;
monitoring a piezoelectric response of the capacitor based at least in part on the measured capacitance; and
detecting a force exerted on the input device based at least in part on the piezoelectric response of the capacitor.

12. The method of claim 11, wherein the measuring comprises:
providing a current to the capacitor;
measuring a voltage response of the capacitor resulting from the current; and
determining the capacitance of the capacitor based at least in part on the measured voltage response.

13. The method of claim 11, further comprising:
coupling the capacitor to a current source when measuring the capacitance of the capacitor; and
decoupling the capacitor from the current source when monitoring the piezoelectric response of the capacitor.

14. The method of claim 11, wherein the capacitance is measured upon startup of the input device and the piezoelectric response is monitored thereafter.

15. The method of claim 11, further comprising:
periodically switching between the measuring of the capacitance and the monitoring of the piezoelectric response.

16. The method of claim 11, further comprising:
processing user inputs based at least in part on the piezoelectric response of the capacitor.

17. An input device, comprising:
a processing system; and
a memory storing instructions that, when executed by the processing system, cause the input device to:
measure a capacitance of a capacitor coupled to the input device;
monitor a piezoelectric response of the capacitor based at least in part on the measured capacitance; and
detect a force exerted on the input device based at least in part on the piezoelectric response of the capacitor.

18. The input device of claim 17, wherein execution of the instructions further causes the input device to:
provide a current to the capacitor;
measure a voltage response of the capacitor resulting from the current; and
determining the capacitance of the capacitor based at least in part on the measured voltage response.

19. The input device of claim 17, wherein execution of the instructions further causes the input device to:
couple the capacitor to a current source when measuring the capacitance of the capacitor; and
decouple the capacitor from the current source when monitoring the piezoelectric response of the capacitor.

20. The input device of claim 17, wherein execution of the instructions further causes the input device to:
process user inputs based at least in part on the piezoelectric response of the capacitor.
